(19) United States
(12) Patent Application Publication
(10) Pub. No.: US 2011/0304421 A1
(43) Pub. Date: Dec. 15, 2011

(54) Ventilation/Heat-Dissipating Structure for Inductor

(76) Inventor: Jung-Fong CHANG, Bade City (TW)

(21) Appl. No.: 12/815,472

(22) Filed: Jun. 15, 2010

(51) Int. Cl. H01F 27/29

(52) U.S. Cl. 336/192; 336/221

(57) ABSTRACT

An inductor includes a magnetic body and a conductive coil received in the magnetic body. The conductive coil receives a magnetic core. The conductive coil includes two terminals exposed outside of the magnetic body. A vent extends through the magnetic core and is spaced from the conductive coil. The vent extends through two opposite sides of the body, forming a path for ambient air. The magnetic body and the magnetic core are preferably integrally formed as a single and inseparable component of the same material.

### BACKGROUND OF THE INVENTION

The present invention relates to ventilation/heat-dissipating structure and, more particularly, to ventilation/heat-dissipating structure suitable for an electronic element such as an inductor.

In manufacture of a conventional inductor, a conductive coil receiving a magnetic core is placed into a chamber of a frame and then fixed in the chamber by a filler or injection material. Two terminals of the conductive coil are bent and located outside of the frame. Since the conductive coil is not integrally formed with the frame, the performance of the conductor is not satisfactory.

Current conductors are formed by pressing metal powders to form a magnetic enveloping layer surrounding the conductive coil through use of a powder press machine and a press die device. Specifically, a conductive coil and metal powders are placed in a cavity of a mold. The metal powders are pressed by upper and lower dies to rapidly form a magnetic enveloping layer surrounding the conductive coil.

Both of conventional inductors and the conductors formed by powder pressing generate a considerable amount of heat during use. In particular, current power conductors require high current and high power during working, aggravating the heat-dissipating problem and adversely affecting the performance and stability of the inductors.

Thus, a need exists for ventilation/heat-dissipating structure to avoid excessive heat during use.

### BRIEF SUMMARY OF THE INVENTION

An objective of the present invention is to provide an inductor including a vent extending axially through a conductive coil of a magnetic body of the inductor to increase the heat-dissipating path and area, to enhance the heat-dissipating efficiency, to increase the heat-dissipating speed, and to obtain satisfactory performance and stable operation while saving energy and allowing automatic mass production of the power inductor.

The present invention fulfills the above objective by providing, in a preferred form, an inductor including a magnetic body and a conductive coil received in the magnetic body. The conductive coil receives a magnetic core. The conductive coil includes two terminals exposed outside of the magnetic body. A vent extends through the magnetic core and is spaced from the conductive coil. The vent extends through two opposite sides of the body, forming a path for ambient air.

In preferred forms, the magnetic body and the magnetic core are integrally formed as a single and inseparable component of the same material. The conductive coil includes a coil portion having a plurality of turns intermediate the terminals. The turns are arranged in an axial direction. The body includes top and bottom faces spaced in the axial direction. The body further includes opposite first and second faces spaced in a direction perpendicular to the axial direction. In a preferred form, the vent extends from the top face through the bottom face. In another preferred form, the vent extends from the first face through the second face.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a top, perspective view of an inductor of a first embodiment according to the preferred teachings of the present invention.

FIG. 2 shows a bottom, perspective view of the inductor of FIG. 1.

FIG. 3 shows a cross sectional view of the inductor of FIG. 1.

FIG. 4 shows a cross sectional view illustrating ventilation/heat-dissipating effect of the inductor of FIG. 1.

FIG. 5 shows a perspective view of an inductor of a second embodiment according to the preferred teachings of the present invention.

FIG. 6 shows a cross sectional view of the inductor of FIG. 5.

FIG. 7 shows a perspective view of an inductor of a third embodiment according to the preferred teachings of the present invention.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

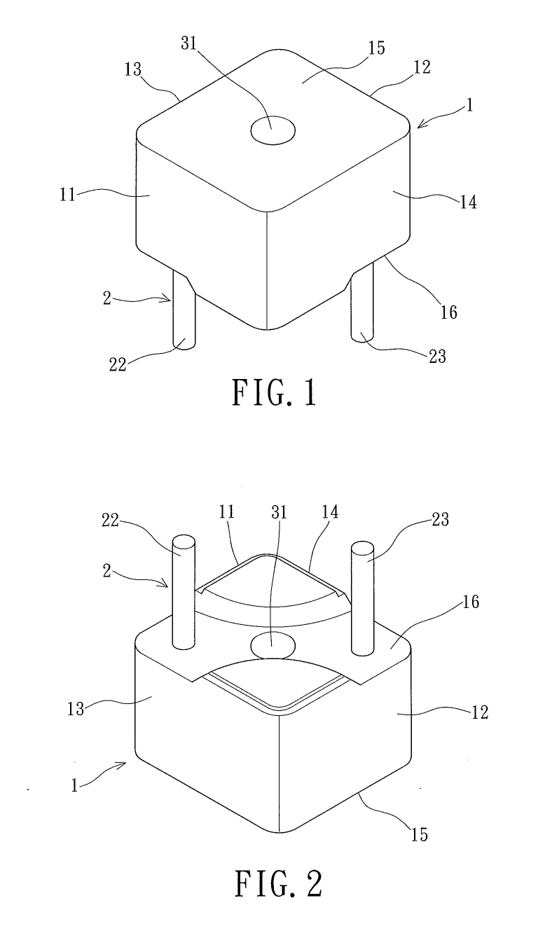

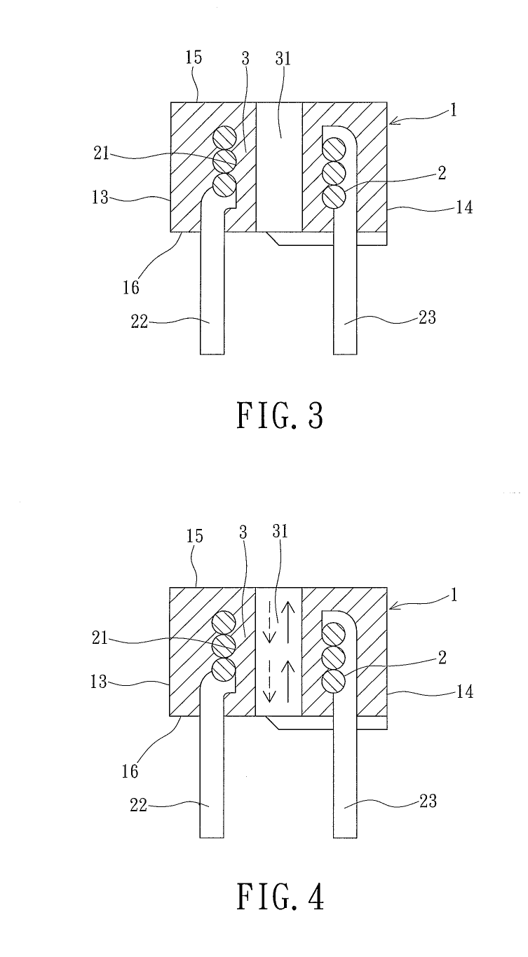

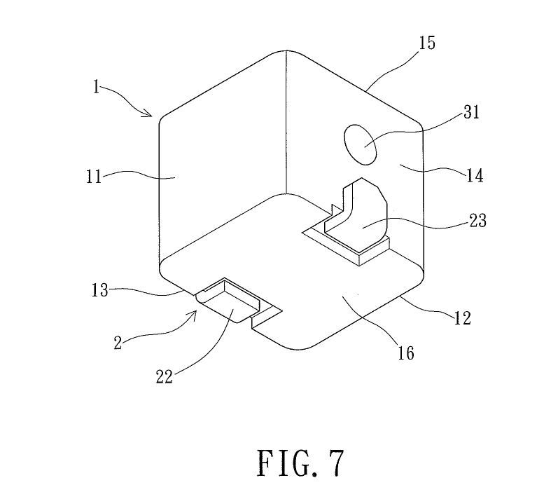

Ventilation/heat-dissipating structure according to the preferred teachings of the present invention is shown in the drawings and generally utilized on an inductor such as a power conductor. In preferred forms shown in FIGS. 1-7, the inductor includes a magnetic body 1 and a conductive coil 2 received in the magnetic body 1. The conductive coil 2 receives a magnetic core 3. The conductive coil 2 includes a coil portion 21 surrounded by and bonded to the magnetic body 1. The coil portion 21 includes a plurality of turns arranged in an axial direction. The conductive coil 2 further includes two terminals 22 and 23 exposed outside of the magnetic body 1 for electrical connection. The coil portion 21 is intermediate the terminals 22 and 23. In the preferred forms shown in FIGS. 1-6, the terminals 22 and 23 are rectilinear. In the preferred form shown in FIG. 7, the terminals 22 and 23 are bent.

In the preferred forms shown in FIGS. 1-7, the inductor further includes a vent 31 extending through the magnetic core 3 and spaced from the conductive coil 2. The vent 31 provides a path for ambient air to move through the magnetic core 3. The magnetic body 1 and the magnetic core 3 are integrally formed as a single and inseparable component of the same material by a suitable process. As an example, powders of oxides of iron, manganese, nickel, and magnesium and other magnetic oxides are mixed (to obtain the required characteristics) with a bonding agent and plastic material and then integrally formed around the conductive coil 2 by powder pressing, forming the inductor with the vent 31. Heat conductive material such as silicon, aluminum or other metal or non-metal heat conductive material as well as anti-oxidation material can be added.

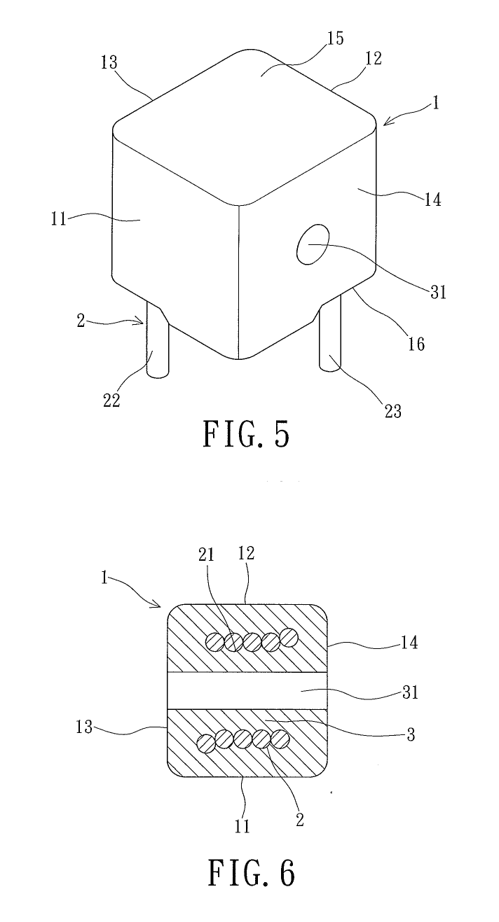

In the preferred forms shown in FIGS. 1-7, the body 1 includes opposite top and bottom faces 15 and 16 spaced in the axial direction, opposite front and rear faces 11 and 12 spaced in a first direction perpendicular to the axial direction, and opposite left and right faces 13 and 14 spaced in a second direction perpendicular to the axial direction and the first direction, forming a cube. In the preferred form shown in FIGS. 1-4, the vent 31 extends from the top face 15 through the bottom face 16 of the body 1. In the preferred forms shown in FIGS. 5-7, the vent 31 extends from the left side 13 through the right side 14 of the body 1. The vent 31 increases the heat-dissipating path and area and the heat-dissipating speed and enhances the heat-dissipating efficiency, obtaining satisfactory performance and stable operation while allowing automatic mass production of the power inductor.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. An inductor comprising a magnetic body and a conductive coil received in the magnetic body, with the conductive coil receiving a magnetic core, with the conductive coil including two terminals exposed outside of the magnetic body, with a vent extending through the magnetic core and spaced from the conductive coil, with the vent extending through two opposite sides of the body, forming a path for ambient air.

2. The inductor as claimed in claim 1, with the conductive coil including a coil portion having a plurality of turns intermediate the two terminals, with the plurality of turns arranged in an axial direction, with the body including top and bottom faces spaced in the axial direction, with the vent extending from the top face through the bottom face.

3. The inductor as claimed in claim 1, with the with the conductive coil including a coil portion having a plurality of turns intermediate the two terminals, with the plurality of turns arranged in an axial direction, with the body including top and bottom faces spaced in the axial direction, with the body further including opposite first and second faces spaced in a direction perpendicular to the axial direction, with the vent extending from the first face through the second face.

4. The inductor as claimed in claim 1, with the magnetic body and the magnetic core integrally formed as a single and inseparable component of a same material.
